(19) United States
(12) Patent Application Publication
(10) Pub. No.: US 2014/0002344 A1
(43) Pub. Date: Jan. 2, 2014

(54) DYNAMIC DISPLAY ADJUSTMENT

(71) Applicant: Mukund Pai, Portland, OR (US)

(72) Inventor: Mukund Pai, Portland, OR (US)

(21) Appl. No.: 13/538,544

(22) Filed: Jun. 29, 2012

(51) Int. Cl. G06F 3/01

(52) U.S. Cl. 345/156

(57) ABSTRACT

An apparatus, comprises logic to detect an indication of eye strain in a user of an electronic device and adjust at least one display parameter on a display of the electronic device in response to the indication of eye strain Other embodiments may be described.

### RELATED APPLICATIONS

None.

### BACKGROUND

The subject matter described herein relates generally to the field of electronic devices and more particularly to a system and method to implement dynamic display adjustment on one or more electronic devices.

Many electronic devices such as computers, laptop computers, tablet computers, personal digital assistants, mobile phones, and the like include one or more electronic displays to present information to a user. Such electronic displays may include adjustable features such as brightness, contrast, font size and the like. Extended use of electronic devices may cause eye strain, particularly if the screen settings are not adjusted appropriately for a user. Accordingly techniques to adjust the display in a dynamic fashion to accommodate changes in users and environments may find utility.

### BRIEF DESCRIPTION OF THE DRAWINGS

The detailed description is described with reference to the accompanying figures.

FIGS. 1-2 are schematic illustrations of exemplary electronic devices which may be adapted to implement dynamic display adjustment in accordance with some embodiments.

FIGS. 3-4 are a flowcharts illustrating operations in part of a method to implement dynamic display adjustment in accordance with, according to embodiments.

FIG. 5 is a schematic illustration of an electronic device which may be adapted to implement dynamic display adjustment, according to embodiments.

### DETAILED DESCRIPTION

Described herein are exemplary systems and methods to implement dynamic display adjustment in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

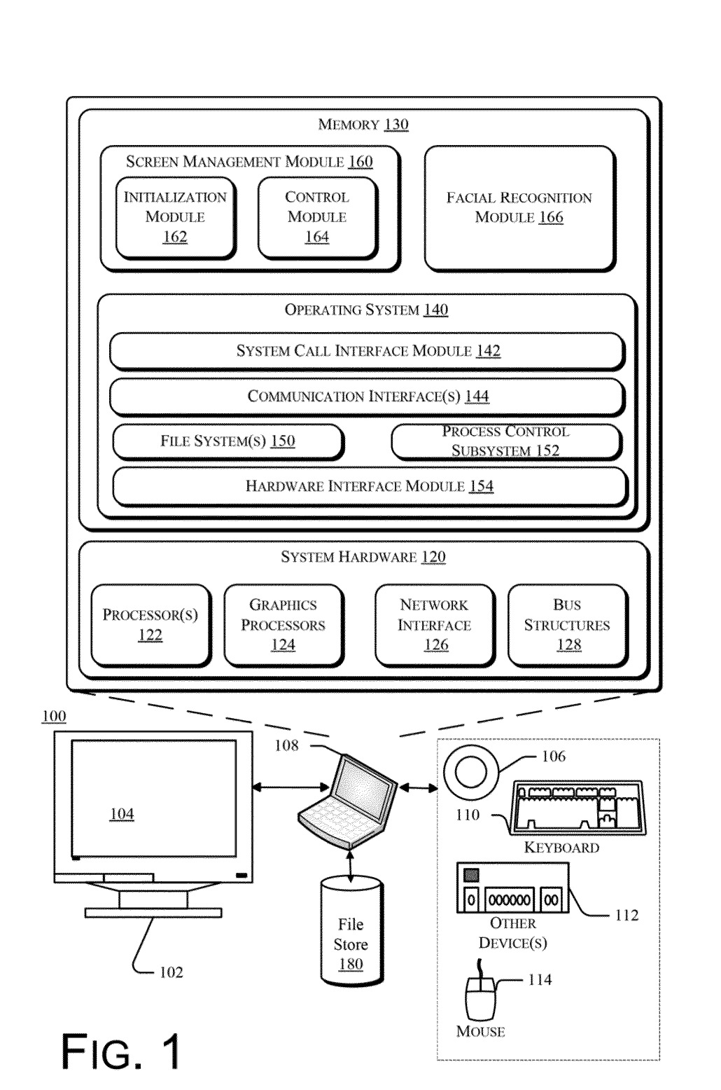

FIG. 1 is a schematic illustration of an exemplary electronic device which may be used to implement dynamic display adjustment in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, at least two graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002). Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In one embodiment, memory 130 includes a screen management module 160 which cooperates with a facial recognition module 166 to implement dynamic display adjustment on the one or more remote devices. In one embodiment, the screen management module 160 comprises an initialization module 162 and a control module 164, each of which may be may be embodied as logic instructions stored in the computer readable memory module 130 of the system 100. In various embodiments the initialization module 162 and control module 164 may be reduced to firmware which may be stored with a basic input/output system (BIOS) for the system 100, or to hardwired logic circuitry, e.g., an integrated circuit (IC). Additional details about the operations implemented by initialization module 162 and control module 164 are described below.

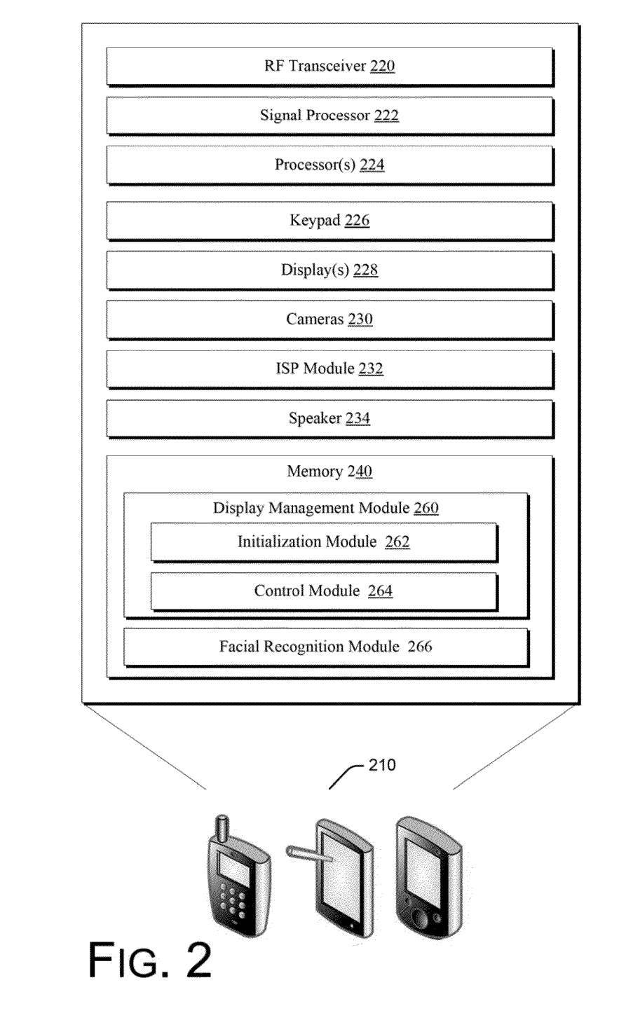

FIG. 2 is a schematic illustration of another embodiment of an electronic device 210 which may be adapted to implement dynamic display adjustment, according to embodiments. In some embodiments electronic device 210 may be embodied as a mobile telephone, a personal digital assistant (PDA), a laptop computer, or the like. Electronic device 210 may include an RF transceiver 220 to transceive RF signals and a signal processing module 222 to process signals received by RF transceiver 220.

RF transceiver 220 may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part H: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 210 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 224 may be one or more processors in the family of Intel® PXA27x processors available from Intel® Corporation of Santa Clara, Calif. Alternatively, other CPUs may be used, such as Intel's Itanium®, XEON™, ATOM™, and Celeron® processors. Also, one or more processors from other manufactures may be utilized. Moreover, the processors may have a single or multi core design. In some embodiments, memory module 240 includes random access memory (RAM); however, memory module 240 may be implemented using other memory types such as dynamic RAM (DRAM), synchronous DRAM (SDRAM), and the like.

Electronic device 210 may further include one or more input/output interfaces such as, e.g., a keypad 226 and one or more displays 228. In some embodiments electronic device 210 comprises one or more camera modules 230 and an image signal processor 232, and speakers 234.

In some embodiments electronic device 210 may include an interrupt display management module 260 which cooperates with a facial recognition module 266 to implement dynamic display adjustment on the electronic device 210. In one embodiment, the screen management module 260 comprises an initialization module 262 and a control module 264, each of which may be may be embodied as logic instructions stored in the computer readable memory module 230 of the electronic device 210. In various embodiments the initialization module 262 and control module 264 may be reduced to firmware which may be stored with a basic input/output system (BIOS) for the electronic device 210, or to hardwired logic circuitry, e.g., an integrated circuit (IC). Additional details about the operations implemented by initialization module 262 and control module 264 are described below.

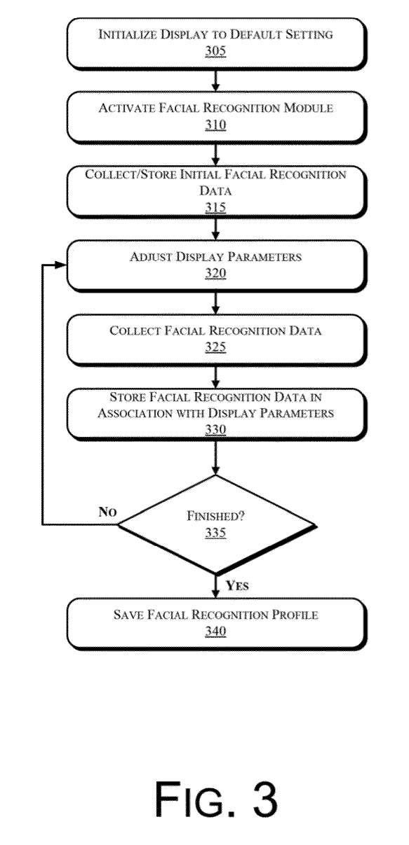

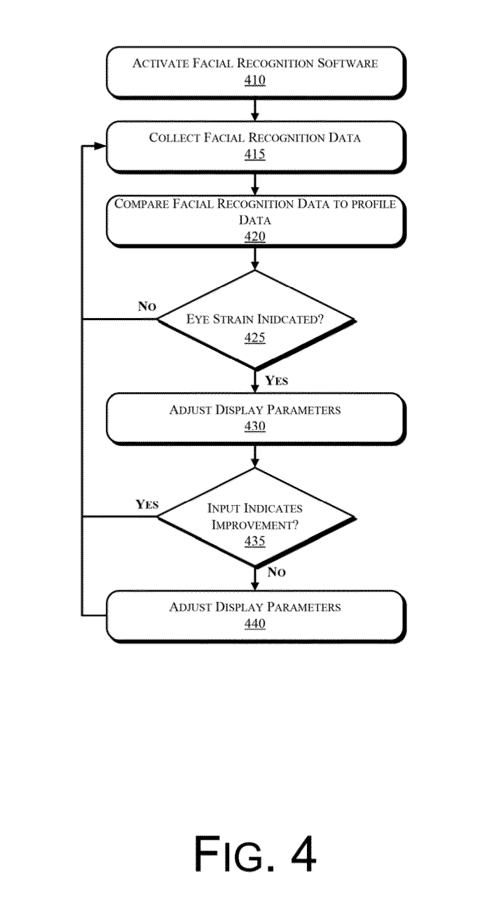

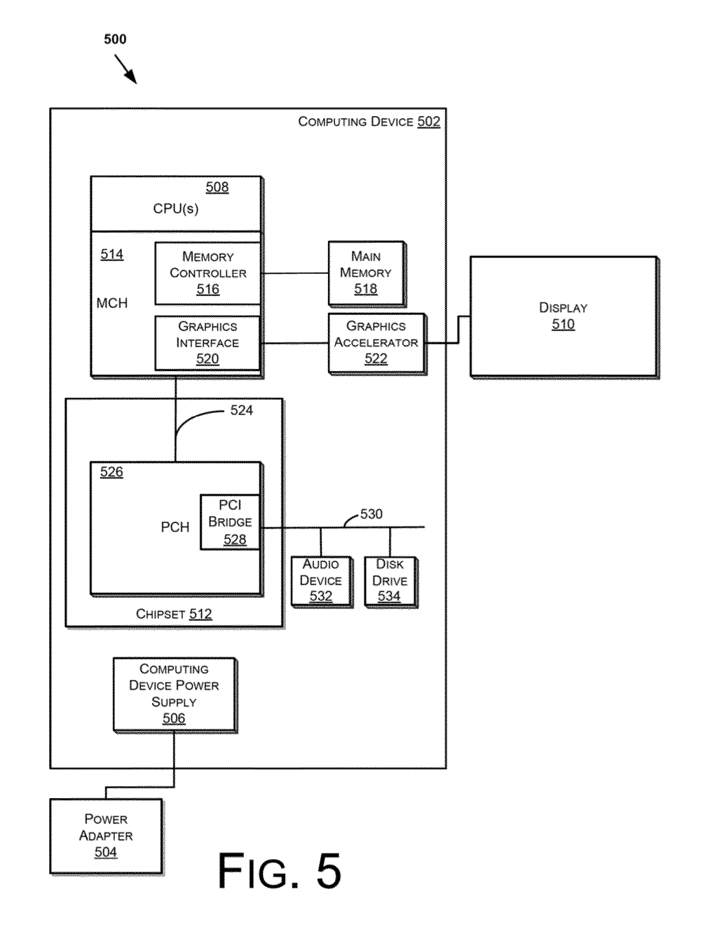

Operations to implement dynamic display adjustment are described with reference to the flowcharts illustrated in FIG. 3 and FIG. 4. In some embodiments the operations of FIG. 3 may be implemented by the initialization modules 162, 262. The operations of FIG. 5 may be implemented by the control module 164, 264.

Referring first to FIG. 3, an initialization module 162, 262 implements operations which construct a user profile of display parameters in association with facial recognition data for the user. In some embodiments the initialization module systematically adjusts display parameters and collects inputs from the facial recognition module 166, 266 and/or from the user via a user interface which indicate whether the user is experiencing eye strain. The facial recognition data may be stored in association with the display parameters to create a personalized user profile which correlates display parameters and facial recognition data indicative of eye strain. In some embodiments the data may further be associated with user inputs indicative of a user's perception of eye strain. In other embodiments the data may represent a depth dimension or proximity of a user's face to the screen. If the computing system detects that the face is too close to the screen, it may take that into consideration and relax the display so that the user increases the distance to the recommended distance that reduces eye strain.

Thus, at operation 305 the display is initialized to a default setting. In some embodiments the default setting may be established to provide an environment of low eye strain. By way of example, the display may be left blank or in a monochromatic state, such that a user need not strain to view the display. At operation 310 the facial recognition module 166, 266 may be activated. In some embodiments the facial recognition module may collect and store (operation 315) facial recognition data from a user's face via an input device, e.g., a camera or the like coupled to the electronic device. The facial recognition data may map facial characteristics such as the shape and width of the user's eyes, etc. The initial facial recognition data may be stored in a data table in a suitable memory in or coupled to the electronic device.

At operation 320 one or more display parameters may be adjusted. In some embodiments the initialization module adjusts the display in a way that is intended to systematically increase eye strain on the user. By way of example, in some embodiments the initialization module may present or scroll text on the display and may progressively decrease the font size of the text. Alternatively, or in addition thereto, the initialization module may alter, e.g., progressively decrease, the display brightness or contrast. At operation 325 facial recognition data is collected and at operation 330 the facial recognition data is stored in association with the display parameters which are active on the display.

If, at operation 335 the initialization process is not finished then control passes back to operation 320 and the initialization module makes further adjustments to one or more display parameters, and collects and stores facial recognition data in association with the display parameters. Thus operations 320-335 form a loop pursuant to which the initialization module 162, 262 may construct a data table which correlates facial recognition data with display parameters.

In some embodiments the initialization module may also collect input from a user via a user interface which allows the user to provide a subjective indication regarding the degree to which current display parameters cause eye strain. By way of example, in some embodiments an eye strain indicator gauge may be presented on the display and a user may be allowed to input a subjective rating of eye strain associated with the current display parameters. This data may be stored in association with the display parameters and the facial recognition data.

By contrast, if at operation 335 the initialization module 162, 262 is finished with the initialization process then control passes to operation 340 and the data generated and collected in operations 320-335 is stored as a facial recognition profile for the current user of the system. The initialization process may then be terminated.

In some embodiments the control module 164, 264 may be implemented to execute as a background process on an electronic device such as the electronic device 100 depicted in FIG. 1 or the electronic devices 210 depicted in FIG. 2. The control module 164, 264 may execute continuously or periodically based upon such factors as, e.g., the power source and of the electronic device, the environment in which the electronic device operates, or the like. In use, the control module monitors facial recognition data received from the facial recognition module during use to determine whether the current display parameters are causing eye strain for the user and automatically adjusts the display characteristics in a manner intended to reduce eye strain.

Referring to FIG. 4, at operation 410 the control module activates the facial recognition software module 166, 266. At operation 415 the control module collects facial recognition data from the facial recognition module. Again, by way of example the facial recognition data collected from the facial recognition module may comprise characteristics such as the shape and width of the user's eyes, etc.

At operation 420 the facial recognition data collected during operation is compared to the facial recognition data stored in the user profile. In some embodiments the control module locates the entry or entries in the user profile which most closely match the facial recognition data collected in operation 415.

At operation 425 a determination is made regarding whether the facial recognition data indicates that the user is experiencing eye strain. By way of example, if the entry or entries in the user profile generated in FIG. 3 that most closely match the facial recognition data collected in operation 415 indicate eye strain, then the data collected at operation 415 may be characterized as indicating eye strain also. By contrast, if the if the entry or entries in the user profile generated in FIG. 3 that most closely match the facial recognition data collected in operation 415 do not indicate eye strain, then the data collected at operation 415 may be characterized as not indicating eye strain also.

In some embodiments the control module may also collect input from a user via a user interface which allows the user to provide a subjective indication regarding the degree to which current display parameters cause eye strain. By way of example, in some embodiments an eye strain indicator gauge similar to the one presented by the initialization module may be presented on the display and a user may be allowed to input a subjective rating of eye strain associated with the current display parameters.

If, at operation 425, eye strain is not indicated then control passes back to operation 415 and the control module continues to collect data from the facial recognition module. By contrast, if at operation 425 eye strain is indicated then control passes to operation 430 and the control module adjusts one or more display parameters. In some embodiments the control module may adjust one or more screen parameters to a setting in the profile that is associated with a lower level of eye strain than the eye strain indicated in the data collected at operation 415.

At operation 415 an input is analyzed to determine whether the adjustments made in operation 430 resulted in an improvement in eye strain for the user. In some embodiments this determination may comprise collecting additional facial recognition data and comparing it to the user profile, or receiving data from an eye strain indicator gauge presented on a user interface. If, at operation 435 the input indicates that the adjusted parameters improved eye strain then control passes to operation 415 and the process continues monitoring facial recognition data. By contrast, if the input indicates that improvements did not result then control passes to operation 440 and further adjustments to display parameters may be implemented before passing control back to operation 415.

Thus, operations 415-440 define a loop by which the control module 164, 264 may monitor facial recognition data from a user of an electronic device and use the facial recognition data to determine an indication of eye strain and to reference a user profile to adjust one or more display parameters in a way that reduces eye strain for the user. In some embodiments operation 415-440 may be repeated until the facial recognition data indicates that the user is not experiencing significant eye strain.

As described above, in some embodiments the electronic device may be embodied as a computer system. FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110VAC to 240VAC) to a direct current (DC) voltage ranging between about 5′VDC to 12.6VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 540 may be coupled to the graphics interface 520 through, for example, a signal converter that translates a digital representation of an image stored in a storage device such as video memory or system memory into display signals that are interpreted and displayed by the display. The display 540 signals produced by the display device may pass through various control devices before being interpreted by and subsequently displayed on the display.

A hub interface 524 couples the MCH 514 to an platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Express™ architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
logic to:
detect an indication of eye strain in a user of an electronic device; and
adjust at least one display parameter on a display of the electronic device in response to the indication of eye strain.

2. The apparatus of claim 1, further comprising logic to construct a user profile of display parameters in association with facial recognition data.

3. The apparatus of claim 2, wherein the logic to construct a user profile of display parameters in association with facial recognition data comprises logic to:
collect facial recognition data from a user when the display is in an initial state;
adjust one or more display parameters;
collect facial recognition data from the user during an operational state; and
store the facial recognition data in association with the display parameters.

4. The apparatus of claim 2, wherein the logic to detect an indication of eye strain in a user of the electronic device comprises logic to:
collect facial recognition data from a user during an operational state; and
compare the facial recognition data with display parameters in the user profile.

5. The apparatus of claim 1, further comprising logic to:
adjust one or more display parameters in response to a user input which indicates that the user is experiencing eye strain.

6. The apparatus of claim 1, wherein the input comprises at least one of:
an analysis of the user's facial recognition data; and
an input from a user via a user interface.

7. An electronic device, comprising:
a display; and
logic to:
detect an indication of eye strain in a user of the electronic device; and
adjust at least one display parameter on the display of the electronic device in response to the indication of eye strain.

8. The electronic device of claim 7, further comprising logic to construct a user profile of display parameters in association with facial recognition data.

9. The electronic device of claim 8, wherein the logic to construct a user profile of display parameters in association with facial recognition data comprises logic to:
collect facial recognition data from a user when the display is in an initial state;
adjust one or more display parameters;
collect facial recognition data from the user during an operational state; and
store the facial recognition data in association with the display parameters.

10. The electronic device of claim 8, wherein the logic to detect an indication of eye strain in a user of the electronic device comprises logic to:
collect facial recognition data from a user during an operational state; and
compare the facial recognition data with display parameters in the user profile.

11. The electronic device of claim 7, further comprising logic to:
adjust one or more display parameters in response to a user input which indicates that the user is experiencing eye strain.

12. The electronic device of claim 7, wherein the user input comprises at least one of:
an analysis of the user's facial recognition data; and
an input from a user via a user interface.

13. A computer program product comprising logic instructions stored on a tangible computer readable medium which, when executed by a processor in an electronic device, configures the processor to:
detect an indication of eye strain in a user of the electronic device; and
adjust at least one display parameter on a display of the electronic device in response to the indication of eye strain.

14. The computer program product of claim 13, further comprising logic instructions stored on a tangible computer readable medium which, when executed by a processor in an electronic device, configures the processor to construct a user profile of display parameters in association with facial recognition data.

15. The computer program product of claim 13, further comprising logic instructions stored on a tangible computer readable medium which, when executed by a processor in an electronic device, configures the processor to:
collect facial recognition data from a user when the display is in an initial state;
adjust one or more display parameters;
collect facial recognition data from the user during an operational state; and
store the facial recognition data in association with the display parameters.

16. The computer program product of claim 13, further comprising logic instructions stored on a tangible computer readable medium which, when executed by a processor in an electronic device, configures the processor to:
collect facial recognition data from a user during an operational state; and
compare the facial recognition data with display parameters in the user profile.

17. The computer program product of claim 16, further comprising logic instructions stored on a tangible computer readable medium which, when executed by a processor in an electronic device, configures the processor to:
adjust one or more display parameters in response to a user input which indicates that the user is experiencing eye strain.

18. The computer program product of claim 17, wherein the user input comprises at least one of:
an analysis of the user's facial recognition data; and
an input from a user via a user interface.

19. A method comprising:
detecting an indication of eye strain in a user of an electronic device; and
adjusting at least one display parameter on a display of the electronic device in response to the indication of eye strain.

20. The method of claim 19, further comprising constructing a user profile of display parameters in association with facial recognition data.

21. The method of claim 20, wherein constructuing a user profile of display parameters in association with facial recognition data comprises:
collecting facial recognition data from a user when the display is in an initial state;
adjusting one or more display parameters;
collecting facial recognition data from the user during an operational state; and
storing the facial recognition data in association with the display parameters.

22. The method of claim 20, further comprising:
collecting facial recognition data from a user during an operational state; and
comparing the facial recognition data with display parameters in the user profile.

23. The method of claim 22, further comprising:
adjusting one or more display parameters in response to a user input which indicates that the user is experiencing eye strain.

24. The method of claim 19, wherein the user input comprises at least one of:
an analysis of the user's facial recognition data; and
an input from a user via a user interface.
